(19) United States
(12) Patent Application Publication
(10) Pub. No.: US 2026/0340671 A1
(43) Pub. Date: Oct. 29, 2026

(54) DETERMINING PERSONALIZED COMPREHENSIVE VEHICLE QUOTES

(71) Applicant: ALLSTATE INSURANCE COMPANY, NORTHBROOK, IL (US)

(72) Inventors: Jeffrey Sholden, Nashville, TN (US); Dana Aldis, Virginia Beach, VA (US); Justin Gannon, Jacksonville, FL (US); Elizabeth Gallery, Chicago, IL (US)

(21) Appl. No.: 19/632,665

(22) Filed: Mar. 30, 2026

Related U.S. Application Data
(60) Provisional application No. 63/780,942, filed on Mar. 31, 2025.

(51) Int. Cl. G06Q 30/0201; G06N 20/00

(52) U.S. Cl. CPC G06Q 30/0206; G06N 20/00; G06Q 30/02016

(57) ABSTRACT

Aspects of the disclosure relate to computer systems and methods for determining personalized comprehensive vehicle quotes comprising a total cost of vehicle ownership. The system and/or method may receive inquiries from consumers regarding vehicles of interest, collect dealer management system data and cost-related data in multiple formats, and generate predictive models for analysis. Using machine learning techniques, the system and/or method may generate comprehensive vehicle quotes that encompass the entire lifecycle cost of vehicle ownership, including financing, insurance, maintenance, warranties, and other ownership-related expenses. For each quote, the system determines likelihood of consumer acceptance and ranks quotes accordingly, producing a ranked list within a predefined range. The system and/or method may integrate fragmented cost information from multiple sources into a unified comprehensive quote, providing transparency and enabling informed purchasing decisions by presenting total ownership costs upfront rather than requiring consumers to obtain separate quotes from disparate sources.

### CROSS-REFERENCE TO RELATED APPLICATIONS

This claims priority to U.S. Provisional Patent Application No. 63/780,942, filed on Mar. 31, 2025, the entire contents of which are incorporated by reference herein.

### FIELD

This invention generally relates computer systems and/or methods for determining personalized comprehensive vehicle quotes.

### BACKGROUND

Prior art vehicle quote systems typically provide only limited cost information to consumers during the vehicle purchasing process, focusing primarily on the immediate purchase price or financing terms without considering the comprehensive financial commitment involved in vehicle ownership. These conventional systems fail to generate vehicle quotes that encompass the total cost of vehicle ownership over the entire lifecycle of owning a vehicle, including ongoing expenses such as insurance premiums, maintenance costs, repair expenses, warranty coverage, and other ownership-related financial obligations that accrue throughout the period of vehicle ownership.

Further, existing quote systems do not provide consumers with the ability to view and evaluate all costs associated with owning a vehicle upfront at the point of vehicle purchase, thereby limiting transparency and preventing consumers from making fully informed decisions regarding the true financial impact of their vehicle acquisition. This fragmented approach to vehicle cost information forces consumers to seek quotes from multiple disparate sources and fails to present a consolidated view of the comprehensive financial commitment required for vehicle ownership, resulting in incomplete cost visibility and suboptimal purchasing decisions.

### SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

The present disclosure provides, in one aspect, a system comprising: at least one processor, a communication interface communicatively coupled to the at least one processor, and memory storing computer-readable instructions that, when executed by the at least one processor, cause the at least one processor to: receive an inquiry from a consumer regarding at least one vehicle of interest, collect cost-related data from one or more sources associated with the least one vehicle of interest, wherein the cost-related data corresponds to a vehicle ownership cost over a lifecycle of vehicle ownership, and generate, using at least one machine learning model, a comprehensive vehicle quote comprising a total cost of vehicle ownership for the at least one vehicle of interest, wherein the comprehensive vehicle quote includes one or more of a vehicle purchase cost, a vehicle policy cost, or the vehicle ownership cost over the lifecycle of vehicle ownership. The system also includes determine, using the at least one machine learning model, a likelihood of acceptance that the consumer accepts the comprehensive vehicle quote, and transmit, based on a determination that the likelihood of acceptance is above a threshold, the comprehensive vehicle quote to a computing device associated with the consumer.

The present disclosure provides, in another aspect, a method comprising: receiving an inquiry from a consumer regarding at least one vehicle of interest; collecting cost-related data from one or more sources associated with the least one vehicle of interest, wherein the cost-related data corresponds to a vehicle ownership cost over a lifecycle of vehicle ownership, and generating, using at least one machine learning model, a comprehensive vehicle quote comprising a total cost of vehicle ownership for the at least one vehicle of interest, wherein the comprehensive vehicle quote includes one or more of a vehicle purchase cost, a vehicle policy cost, or the vehicle ownership cost over the lifecycle of vehicle ownership. The method also includes determining, using the at least one machine learning model, a likelihood of acceptance that the consumer accepts the comprehensive vehicle quote, and transmitting, based on a determination that the likelihood of acceptance is above a threshold, the comprehensive vehicle quote to a computing device associated with the consumer.

The present disclosure provides, in another aspect, one or more non-transitory computer-readable media storing instructions that, when executed by a processor, cause the processor to: receive an inquiry from a consumer regarding at least one vehicle of interest; collect cost-related data from one or more sources associated with the least one vehicle of interest, wherein the cost-related data corresponds to a vehicle ownership cost over a lifecycle of vehicle ownership, and generate, using at least one machine learning model, a comprehensive vehicle quote comprising a total cost of vehicle ownership for the at least one vehicle of interest, wherein the comprehensive vehicle quote includes one or more of a vehicle purchase cost, a vehicle policy cost, or the vehicle ownership cost over the lifecycle of vehicle ownership. The one or more non-transitory computer-readable media storing instructions also includes determine, using the at least one machine learning model, a likelihood of acceptance that the consumer accepts the comprehensive vehicle quote, and transmit, based on a determination that the likelihood of acceptance is above a threshold, the comprehensive vehicle quote to a computing device associated with the consumer.

The arrangements described can also include other additional elements, steps, computer-executable instructions, or computer-readable data structures. In this regard, other embodiments are disclosed and claimed herein as well. The details of these and other embodiments of the present invention are set forth in the accompanying drawings and the description below. Other features and advantages of the invention will be apparent from the description, drawings, and claims.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals.

FIG. 1 depicts a computing environment for a vehicle quote device according to one or more embodiments.

FIG. 2 depicts a computing environment for a vehicle quote determination and analysis system according to one or more embodiments.

FIG. 3 depicts a flow chart illustrating a method for determining one or more comprehensive vehicle quote according to one or more embodiments.

FIGS. 4 and 5 depicts a flow chart illustrating a method for determining one or more comprehensive vehicle quote using machine learning techniques according to one or more embodiments.

FIG. 6 depicts a comprehensive vehicle quote according to one or more embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Described herein are systems and methods for determining personalized comprehensive vehicle quotes comprising a total cost of vehicle ownership. For example, a computing system using one or more computer models (e.g., predictive, machine learning, generative artificial intelligence, large language model, small language model) may determine one or more comprehensive vehicle quotes for a consumer. In embodiments, the consumer may be seeking a comprehensive vehicle quote to understand one or more costs associated with owning a vehicle over a period of time. The comprehensive vehicle quote may include a total cost of ownership for a vehicle of interest. In other words, the comprehensive vehicle quote may include a vehicle cost quote for a period of time that a consumer owns a vehicle. The comprehensive vehicle quote may include one or more quotes for vehicles, finance and insurance (F&I) products, and/or other products or services (e.g., repairs, recalls, etc.) associated with cost of vehicle ownership. For example, a dealership, an insurance company, and/or a banking institution may offer a vehicle of interest and the associated finance and insurance products.

The comprehensive vehicle quote allows a consumer to view the total cost of owning the vehicle of interest before making a vehicle purchase. The systems and methods described in this disclosure may increase transparency of vehicle ownership costs which may result in increased consumer satisfaction of the vehicle purchasing process, and loyalty for a dealership or insurance provider. The systems and methods described in this disclosure may generate the comprehensive vehicle quote comprising the total cost of vehicle ownership in one location (e.g., mobile application running on a mobile computing device, computing device) rather than fragmented quotes across different dealerships, and enterprises offering finance and insurance products.

Further, the computing system and/or method as described in this disclosure may utilize machine learning techniques to determine personalized comprehensive vehicle quotes to a consumer based on historical data (e.g., historical purchases of vehicles and/or finance and insurance products). The computing system, using one or more machine learning techniques, may provide one or more comprehensive vehicle quotes ranked on a predetermined ranking range to a consumer. Providing personalized comprehensive vehicle quotes may increase consumer satisfaction with the vehicle purchasing process thereby increasing a likelihood of a consumer closing or accepting a personalized comprehensive vehicle quote.

The one or more computer models may receive multiple types of data (e.g., structured, unstructured, etc.) corresponding to vehicles, and/or finance and insurance products from a plurality of consumers and dealerships. The one or more models may be trained using the multiple types of data to output predicted comprehensive vehicle quotes that may have a high likelihood of closing (i.e., acceptance, purchased) by a consumer. The one or more models trained with machine learning techniques may generate comprehensive vehicle quote data that may be capable of being ranked or sent to other computing devices for display or analysis. The one or more models may improve the processing of large amounts of data (e.g., historical, current, real-time, near real-time, enterprise data, dealer management system data, consumer data, third party data) to generate the comprehensive vehicle quote for a consumer.

### Computing Systems and Operating Environment

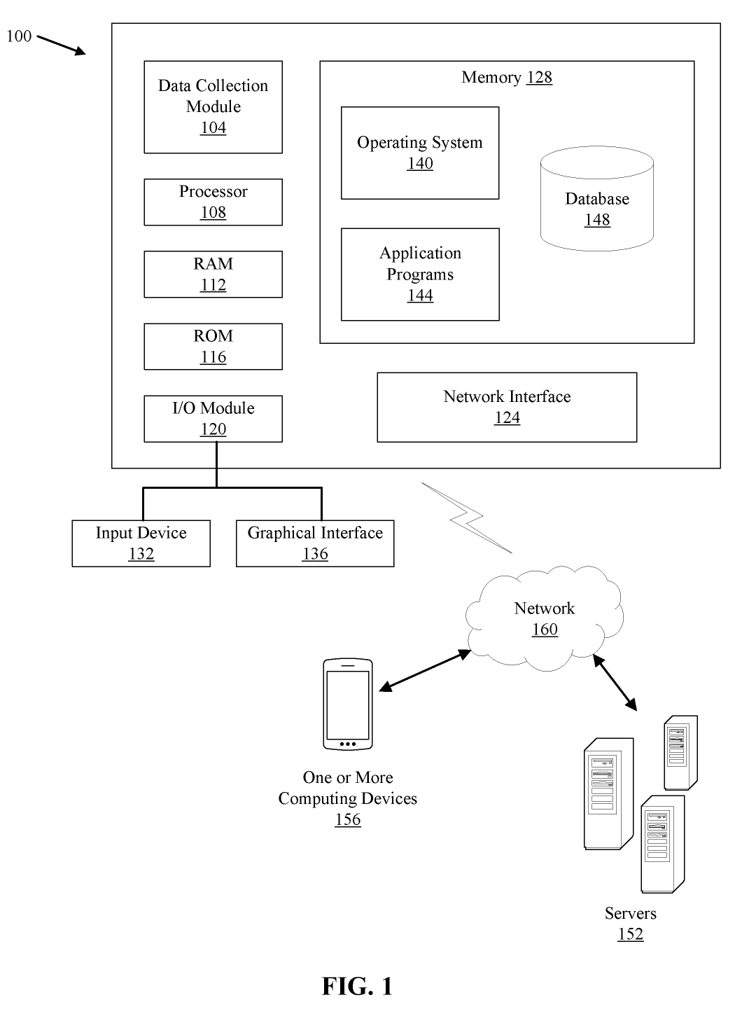

In one or more arrangements, aspects of the present disclosure may be implemented with a computing device. FIG. 1 illustrates a block diagram of an example computing environment including a vehicle quote device 100 according to one or more embodiments. The vehicle quote device 100 may be a computing device, such as a personal computer (e.g., a desktop computer), server, cloud-based server, server blade, laptop computer, notebook, tablet, smartphone, etc. The vehicle quote device 100 may have a data collection module 104 for retrieving and/or analyzing data as described in this disclosure. The data collection module 104 may be implemented with one or more processors and one or more storage units (e.g., databases, RAM, ROM, and other computer-readable media), one or more application specific integrated circuits (ASICs), field programmable gate arrays (FPGA), and/or other hardware components (e.g., resistors, capacitors, power sources, switches, multiplexers, transistors, inverters, etc.). Throughout this disclosure, the data collection module 104 may refer to the software and/or hardware used to implement the data collection module 104. In cases where the data collection module 104 includes one or more processors, such processors may be specially configured to perform the processes disclosed herein. Additionally, or alternatively, the data collection module 104 may include one or more processors configured to execute computer-executable instructions, which may be stored on a storage medium, to perform the processes disclosed herein.

In some examples, the vehicle quote device 100 may include one or more processors 108 in addition to, or instead of, the data collection module 104. The processor(s) 108 may be configured to operate in conjunction with data collection module 104. Both the data collection module 104 and the processor(s) 108 may be capable of controlling operations of the vehicle quote device 100 and its associated components, including RAM 112, ROM 116, an input/output (I/O) module 120, a network interface 124, and memory 128. For example, the data collection module 104 and processor(s) 108 may each be configured to read/write computer-executable instructions and other values from/to the RAM 112, ROM 116, and memory 128.

The I/O module 120 may be configured to be connected to an input device 132, such as a microphone, keypad, keyboard, touchscreen, and/or stylus through which a user of the vehicle quote device 100 may provide input data. The I/O module 120 may also be configured to be connected to a graphical interface 136, such as a display device, a monitor, television, touchscreen, etc., and may include a graphics card. For example, the I/O module 120 may be configured to receive data from a user. As shown in FIG. 1, the graphical interface 136 and input device 132 may be separate elements from the vehicle quote device 100. However, in other embodiments, the input device 132 and the graphical interface 136 may be within the same structure. In some embodiments, the input device 132 may be operated by a user to interact with the data collection module 104, including providing information about one or more vehicles, one or more finance and insurance (F&I) products, inquiries for comprehensive vehicle quotes, etc., as described in further detail below. System administrators may use the input device 132 to make updates to the data collection module 104, such as software updates. Meanwhile, the graphical interface 136 may assist the system administrators and users to confirm/appreciate their inputs.

The memory 128 may be any computer-readable medium for storing computer-executable instructions (e.g., software). The instructions stored within memory 128 may enable the vehicle quote device 100 to perform various functions as described in this disclosure. For example, memory 128 may store software used by the vehicle quote device 100, such as an operating system 140 and application programs 144, and may include an associated database 148.

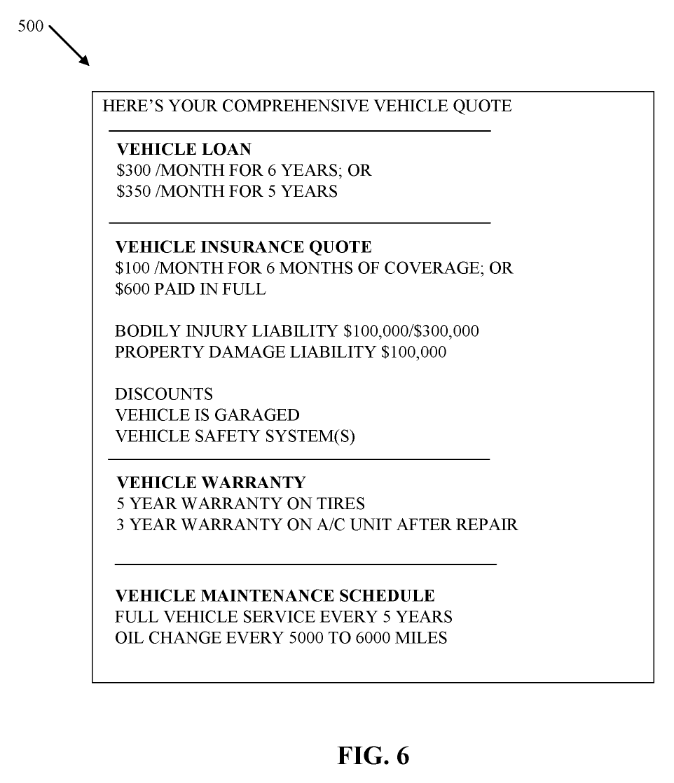

Although not shown in FIG. 1, various elements within memory 128 or other components in the vehicle quote device 100, may include one or more caches, for example, CPU caches used by a processing unit, page caches used by the operating system 140, disk caches of a hard drive, and/or database caches used to cache content from database 148. For embodiments including a CPU cache, the CPU cache may be used by one or more processors in the processor 108 to reduce memory latency and access time. In such examples, the processor 108 may retrieve data from or write data to the CPU cache rather than reading/writing to memory 128, which may improve the speed of these operations. In some examples, a database cache may be created in which certain data from a central database such as, for example, one or more enterprise servers 152 (e.g., a claims database, an underwriting database, insurance customer database, local information database, insurance policies, etc.) is cached in a separate smaller database on an application server separate from the database server. For instance, in a multi-tiered application, a database cache on an application server can reduce data retrieval and data manipulation time by not needing to communicate over a network with a back-end database server such as, for example, one or more enterprise servers 152. These types of caches and others may be included in various embodiments, and may provide potential advantages in certain implementations of retrieving and analyzing vehicle data, dealer management data, consumer data, such as faster response times and less dependence on network conditions when transmitting/receiving data from one or more enterprise servers 152, one or more computing devices 156, etc. In some embodiments, the one or more enterprise servers 152 may be associated with an enterprise such as an insurance company. In some embodiments, the one or more computing devices 156 may be associated with a dealership that offers one or more vehicles and/or vehicle services. In some embodiments, the one or more computing devices 156 may be associated with one or more consumers seeking one or more comprehensive vehicle quotes (e.g., comprehensive vehicle quote 500 of FIG. 6) as described in more detail below.

The network interface 124 may allow vehicle quote device 100 to connect to and communicate with a network 160. The network 160 may be any type of network, including a local area network (LAN) and/or a wide area network (WAN), such as the Internet, a cellular network, or satellite network. Through network 160, vehicle quote device 100 may communicate with one or more other computing devices such as the one or more computing devices 156 (e.g., laptops, notebooks, mobile devices, smartphones, tablets, personal computers, servers, vehicles, home management devices, home security devices, smart appliances, computing devices positioned within vehicles, etc.). Through network 160, vehicle quote device 100 may also communicate with the one or more enterprise servers 152 to exchange related information and data.

Network interface 124 may connect to the network 160 via communication lines, such as coaxial cable, fiber optic cable, etc., or wirelessly using a cellular backhaul or a wireless standard, such as IEEE 802.11, IEEE 802.15, IEEE 802.16, etc. Further, network interface 124 may use various protocols, including TCP/IP, Ethernet, File Transfer Protocol (FTP), Hypertext Transfer Protocol (HTTP), etc., to communicate with vehicle 156, the one or more computing devices 156, and enterprise servers 152.

It will be appreciated that the network connections shown are illustrative and other means of establishing a communications link between the computers may be used. The existence of any of various network protocols such as Transmission Control Protocol/Internet Protocol (“TCP/IP”), Ethernet, File Transfer Protocol (“FTP”), Hypertext Transfer Protocol (“HTTP”) and the like, and of various wireless communication technologies such as the Global System for Mobile Communications (“GSM”), Code Division Multiple Access (“CDMA”), Wi-Fi, Long-Term Evolution (“LTE”), and Worldwide Interoperability for Microwave Access (“WiMAX”), is presumed, and the various computing devices and mobile device location and configuration system components described herein may be configured to communicate using any of these network protocols or technologies.

### Vehicle Quote Determination and Analysis System

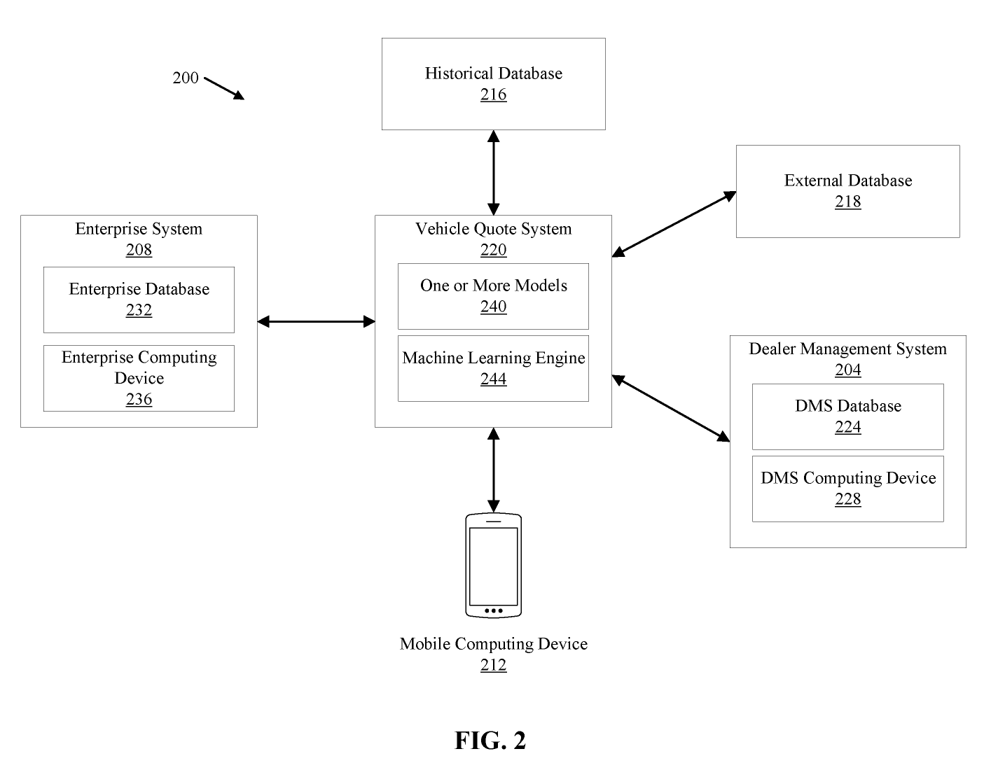

FIG. 2 illustrates a computing environment for a vehicle quote determination and analysis system 200 according to one or more embodiments. The computing environment may include a dealer management system 204 (hereafter the “DMS 204”), an enterprise system 208, a mobile computing device 212, a historical database 216, an external database 218, and a vehicle quote system 220. The DMS 204, the enterprise system 208, the mobile computing device 212, the historical database 216, the vehicle quote system 220, and/or combinations thereof may be equipped to communicate with devices, services, databases, etc. over a network (e.g., network 160, private, public, or other network type).

As shown in FIG. 2, the DMS 204 may work in conjunction with the enterprise system 208, the mobile computing device 212, the historical database 216, and the vehicle quote system 220 to receive, process, and/or send data associated with providing vehicle costs or one or more other costs associated with a vehicle for the generation of a comprehensive vehicle quote (e.g., comprehensive vehicle quote 500 of FIG. 6). The DMS 204 may be associated with a dealership that offers one or more vehicles (e.g., new, used, parts, etc.) for sale, and/or vehicle services (e.g., sales, repairs, trade-ins, guidance on vehicle loans, etc.). The DMS 204 may be associated with one or more dealerships that offer vehicles for sale, and/or vehicle services. In some embodiments, the DMS 204 may be associated with a plurality of dealerships that provide vehicles and/or vehicle services. In other embodiments, the vehicle quote analysis and determination system 200 may be in communication with one or more DMS 204, where each DMS 204 includes data associated with one or more automotive dealerships.

The DMS 204 may support different aspects of operating a dealership such as tracking sales, parts, inventory, finance, and administration involved with the sale of vehicles. The DMS 204 may also provide automatic processing of purchases, warranty claims, price lists, and the like. For example, the DMS 204 may provide vehicle information such as vehicle identification number (VIN), type of vehicle, price of vehicle, manufacturer suggested retail price (MSRP), vehicle location data, service cots, repair costs, and/or any other information associated with vehicles. For example, when purchasing a new vehicle or trading in a used vehicle, a consumer may request the associated vehicle information from the DMS 204. In some embodiments, the DMS 204 may provide one or more finance or insurance products of services (F&I products or services). In these embodiments, the DMS 204 may provide current data and/or historical data associated with one or more F&I products or services.

With continued reference to FIG. 2, the DMS 204 may include an DMS database 224 and a DMS computing device 228. The DMS database 224 may be configured to store and provide data or information corresponding to one or more vehicles. The DMS database 224 may be indicative of transactional data relating to one or more automotive products or services. The DMS database 224 may store data or information associated with transactional data relating to one or more of current acquisition of vehicles by consumers and/or past acquisition of vehicles by other consumers. The transactional data may include transactions associated with vehicle sales, vehicle maintenance events, vehicle service events, or other vehicle transactions associated with a vehicle cost.

The DMS computing device 228 may be or include one or more components described with respect to the vehicle quote device 100 as shown in FIG. 1. The DMS computing device 228 may receive requests for vehicle information from one or more consumers, and/or one or more enterprises. For example, as shown in FIG. 2, the DMS computing device 228 may be in communication with the mobile computing device 212 associated with a consumer. The mobile computing device 212 may be associated with a consumer. The consumer may, via the mobile computing device 212, request vehicle information from the DMS computing device 228. In another example, the DMS computing device 228 may be in communication with the enterprise system 208. The DMS computing device 228 may request insurance policy information for one or more vehicles in a dealership’s inventory. The DMS computing device 228 may display, via a graphical user interface, vehicle information, or other vehicle information that may needed to inform a consumer about a total cost of owning a vehicle.

As shown in FIG. 2, the enterprise system 208 may work in conjunction with the DMS 204, the mobile computing device 212, the historical database 216, and the vehicle quote system 220 to receive, process, and/or send data associated with a request to generate a comprehensive vehicle quote for a consumer. The enterprise system 208 may be associated with an enterprise such as an insurance company that provides one or more insurance products (e.g., auto or home). For example, the enterprise system 208 may provide insurance policy details associated with a vehicle or a home, and/or insurance policy quotes. For example, when purchasing a new vehicle or trading in a used vehicle, the consumer may request insurance policy information from the enterprise system 208 for one or more vehicles of interest. For example, the enterprise system 208 may provide one or more finance or insurance products of services. The finance or insurance products or services may also be referred to as F&I products or services. The finance or insurance products or services may also be referred to as finance or insurance items (generally referred to as “F&I items”). A consumer may also be referred to as a user, a human user, a consumer, an individual consumer, or a customer.

With continued reference to FIG. 2, the enterprise system 208 may include an enterprise database 232 and an enterprise computing device 236. The enterprise database 232 may be configured to store and provide data or information corresponding to insurance policies for vehicles, homes, other items, other properties, and/or combinations thereof. The enterprise database 232 may store and provide insurance policies, insurance policy quotes (e.g., historical, current, real-time), other insurance product information for a plurality of vehicles, homes, and/or other consumers.

The enterprise computing device 236 may be or include one or more components discussed with respect to the vehicle quote device 100 as shown in FIG. 1. The enterprise computing device 236 may receive requests for insurance product information from one or more consumers. For example, as shown in FIG. 2, the enterprise computing device 236 may be in communication with the mobile computing device 212 associated with a consumer. The mobile computing device 212 may request insurance product information from the enterprise system 208 or the enterprise computing device 236. In another example, the enterprise computing device 236 may be in communication with the DMS computing device 228, where the DMS computing device 228 may request insurance policy information from the enterprise system 208 or the enterprise computing device 236. The enterprise computing device 236 may request vehicle information (e.g., make, model, year, status, warranty, etc.) for one or more vehicles from the DMS 204. The enterprise computing device 236 may display, via a graphical user interface, insurance policy information, or other insurance product information that may needed to inform a consumer about a total cost of owning a vehicle.

The mobile computing device 212 may work in conjunction with the DMS 204, the enterprise system 208, the historical database 216, and the vehicle quote system 220 to generate a comprehensive vehicle quote. In some embodiments, the mobile computing device 212 may communicate with the computing systems of the vehicle quote determination and analysis system 200 through a software application or mobile application running on the mobile computing device 212. The mobile computing device 212 may be associated with a consumer inquiring about one or more comprehensive vehicle quotes. The mobile computing device 212 may be a mobile device, a cell phone, a tablet, a personal digital assistance, or a desktop or laptop computer. In other embodiments, the mobile computing device 212 may communicate with the computing systems of the vehicle quote determination and analysis system 200 via a software, server, cloud-based server, other service that executes or runs on the mobile computing device 212.

The historical database 216 may store information used by the enterprise system 208, the DMS 204, and the vehicle quote system 220 to generate a comprehensive vehicle quote. The historical database 216 may be configured to store and provide historical data associated with insurance product transactions, vehicle transactions, transactions between a consumer and an insurance company, transactions between a consumer and a dealership, and/or any combination thereof. The historical data may include vehicle information such as make, model, year, usage status (e.g., new or used). The historical data may include insurance policy information associated with a plurality of vehicles, vehicle information from a plurality of dealerships, dealership vehicle inventory, etc. The historical data may include data for a plurality of finance and insurance (F&I) products.

The external database 218 may store information used by the DMS 204, enterprise system 208, the historical database 216, and the vehicle quote system 220. The external database 218 may work in conjunction or communicate with a computing device comprising one or more components described with respect to the vehicle quote device 100 as shown in FIG. 1. The external database 218 may provide supplementary and/or additional information corresponding with a total cost of vehicle ownership to the vehicle quote system 220. The external database 218 may be configured to store and provide data that supplements the generation of a comprehensive vehicle quote. For example, the external database 218 may comprise data or information corresponding to transactions associated with insurance products, vehicle quotes, transactions between a consumer and an insurance company, transactions between a consumer and a dealership, and/or combinations thereof.

The external database 218 may be associated with original equipment manufacturers (OEM), third-parties, other enterprises, other services, other software applications, other APIs, and/or any combination thereof that supplements the determination of a comprehensive vehicle quote which may include a vehicle quote, insurance product quote, and/or a finance or insurance (F&I) product quote. For example, the external database 218 may be associated with an automotive research company that provides services related to determining a value of a vehicle upon sale or trade-in. For example, the external database 218 may be associated with a financial or banking institution that provides financial services such as vehicle loans or other financial products corresponding to one or more costs associated with the vehicle. For example, the external database 218 may be associated with an original equipment manufacturer (OEM) that supplies vehicles and suggest vehicle prices (e.g., MSRP).

In other embodiments, the external database 218 may be configured to store and provide data from one or more third parties that supplement the generation of a comprehensive vehicle quote. For example, the external database 218 may store and provide data corresponding to dynamic vehicle trade-in value, vehicle depreciation schedules, vehicle tax rates (e.g., current or projected), vehicle recall data, vehicle appointment scheduling integration, used vehicle listings, used vehicle history, financial products or services, and/or vehicle consumer reviews (e.g., vehicle review enterprises or websites). The external database 218 may work in conjunction or communication with a computing device comprising one or more components described with respect to the vehicle quote device 100 as shown in FIG. 1. The external database 218 may provide supplementary and/or additional information corresponding with a total cost of vehicle ownership to the vehicle quote system 220.

With continued reference to FIG. 2, the vehicle quote system 220 may be or include one or more components described with respect to the vehicle quote device 100 as shown in FIG. 1. In some embodiments, the vehicle quote system 220 may be housed on a server, a computing device, or other computing devices. The vehicle quote system 220 may perform the processes described in this disclosure, and may be equipped to communicate with devices, servers, databases, etc. over a network (e.g., private, public, or other network type). The vehicle quote system 220 may collect information from and transmit information to each of the various applications, databases, devices, and backend servers described in FIG. 1.

In embodiments, the vehicle quote system 220 may output one or more comprehensive vehicle quotes that have a high likelihood of closing to a consumer. In embodiments, the vehicle quote system 220 may output one or more comprehensive vehicle quotes that include a likelihood of acceptance above a threshold to a consumer (e.g., threshold may be determined by an enterprise). The vehicle quote system 220 may output one or more comprehensive vehicle quotes tailored to a consumer. In embodiments, the likelihood of closing a vehicle quote may represent a likelihood of a consumer accepting or purchasing the comprehensive vehicle quote from the vehicle quote system 220. The comprehensive vehicle quote may also be referred to as a total cost of vehicle ownership. The comprehensive vehicle quote may also be referred to as a customized vehicle quote. The vehicle quote system 220 may receive a request to provide a comprehensive vehicle quote from a consumer. For example, the vehicle quote system 220 may receive the request for the comprehensive vehicle quote from the mobile computing device 212 associated with a consumer.

The comprehensive vehicle quote may include a total cost of owning a vehicle which may include one or more of a cost of an insurance policy, a vehicle loan, a vehicle extended warranty, other vehicle finance and insurance products, maintenance events, service events, and/or other costs that may contribute to the total cost of owning the vehicle. In embodiments, the comprehensive vehicle quote may include a vehicle quote and an insurance policy quote. In embodiments, the comprehensive vehicle quote may include a vehicle quote, an insurance policy, and a vehicle loan quote. In embodiments, the comprehensive vehicle quote may include a vehicle quote, and one or more vehicle maintenance event quotes. In embodiments, the comprehensive vehicle quote may include vehicle loan, vehicle insurance quote, vehicle warranty, and vehicle maintenance schedule details (e.g., comprehensive vehicle quote 500 of FIG. 6). It would be appreciated that the comprehensive vehicle quote may include one or more cost quotes associated with a total cost of vehicle ownership or owning a vehicle.

Further, in other embodiments, the vehicle quote system 220 may generate or output one or more comprehensive vehicle quotes as a vehicle ages. The vehicle age may be referred to as a lifecycle of the vehicle. In other words, the vehicle quote system 220 may generate or output one or more comprehensive vehicle quotes over a lifecycle of the vehicle (e.g., a period of time from purchasing a vehicle to selling/trading in the vehicle). In embodiments, the vehicle quote system 220 may generate or output one or more comprehensive vehicle quotes at a specific point in time during a lifecycle of the vehicle. In embodiments, the vehicle quote system 220 may generate one or more comprehensive vehicle quotes at a point of vehicle sale (e.g., initial purchase), a point of vehicle trade-in, a period of time after purchase (e.g., 5-year, 10-year, etc.), a maintenance service event, a vehicle or vehicle part recall event, etc. In embodiments, the one or more comprehensive vehicle quotes may comprise any cost that contributes to the total cost of vehicle ownership.

In other embodiments, the vehicle quote system 220 may receive data from other computing systems in the computing environment such as the external database 218, a vehicle gas supplier, a vehicle manufacturer, and/or an automotive research company. In embodiments, the comprehensive vehicle quote may be adjusted based on one or more factors such as gas prices, manufacturer’s suggest retail price (MSRP), etc.

Still, in other embodiments, the vehicle quote system 220 may offer discounts, rewards, incentives that modify, adjust, or alter a comprehensive vehicle quote. For example, a consumer may provide information that indicates the consumer will service or maintain their vehicle at particular dealerships that have partnered with an insurance company. In embodiments, a consumer may commit to servicing their vehicle at a particular dealership at the initial comprehensive quote determination. The consumer may receive updated comprehensive vehicle quotes during a lifecycle of owning a vehicle (e.g., initial purchase, service activities, maintenance activities, sale, trade-in). The lifecycle of owning a vehicle may be respect to a consumer’s ownership of the vehicle or a period of time the consumer owns the vehicle.

The consumer may receive automatically, via the vehicle quote system 220, one or more comprehensive vehicle quotes during a lifecycle of owning a vehicle and/or specific points during the lifecycle of owning the vehicle. Described in another way, the vehicle quote system 220 may transmit or automatically transmit one or more comprehensive vehicle quotes during a lifecycle of owning a vehicle and/or specific points during the lifecycle of owning the vehicle. In embodiments, the vehicle quote system 220 may detect (e.g., a detection module, a sensor associated with a vehicle, the mobile computing device 212, and/or computing device in communication with the vehicle quote system 220) one or more vehicle events during a lifecycle of owning a vehicle, and automatically transmit one or more comprehensive vehicle quotes to a consumer to update the consumer on a total cost of owning the vehicle. In embodiments, the vehicle quote system 220 may provide a consumer with one or more comprehensive vehicle quotes periodically or at intervals (e.g., automatically, triggered based on one or more vehicle events) during a lifecycle of owning the vehicle.

The consumer may modify or adjust (e.g., reduced cost, lower quotes including vehicle, insurance products, finance products, etc.) the comprehensive vehicle quote by servicing their vehicle at partnered dealerships or third-party vendors. In embodiments, the vehicle quote system 220 may generate a vehicle service or maintenance schedule that a consumer may follow during the vehicle ownership lifecycle. In embodiments, a consumer may modify or alter the comprehensive vehicle quote by completing certain service or maintenance events according to the generated vehicle maintenance schedule during the vehicle ownership lifecycle.

The vehicle quote system 220 may communicate with the DMS 204 to obtain information for one or more vehicles of interest. In embodiments, a consumer may submit an inquiry to the vehicle quote system 220. The vehicle quote system 220 may communicate with the enterprise system 208 to obtain information for one or more insurance products for the one or more vehicles interest. The vehicle quote system 220 may communicate with the historical database 216 to obtain historical insurance product and/or vehicle information that may be needed to provide the comprehensive vehicle quote to a consumer. As described in more detail below, the vehicle quote system 220 may use predictive analytics to generate a comprehensive vehicle quote for a consumer (e.g., comprehensive vehicle quote 500 of FIG. 6).

As shown in FIG. 2, the vehicle quote system 220 may include one or more models 240, and a machine learning engine 244. The vehicle quote system 220 may utilize the one or more models 240 (e.g., statistical, propensity, probabilistic, machine learning, generative artificial intelligence, or other models) to generate a comprehensive vehicle quote for a consumer. The vehicle quote system 220 may also utilize the machine learning engine 244 and historical data stored in the historical database 216 to train the one or more models 240 to generate one or more comprehensive vehicle quotes for a consumer.

The one or more models 240 may receive information or data from the DMS 204, the enterprise system 208, the historical database 216, the external database 218, and the mobile computing device 212 associated with the consumer as an input. For example, the one or more models 240 may receive structured data (e.g., tabular data) or unstructured data (e.g., text data, free form text data) associated with one or more of insurance products, vehicles, or consumer information. The one or more models 240 may receive data or information in one or more formats from the computing systems of the vehicle quote determination and analysis system 200. In other words, the data or information from the computing systems of the vehicle quote determination and analysis system 200 may include multiple data formats. The one or more models 240 may receive data in real-time, continuously, or at intervals from the computing systems of the vehicle quote determine and analysis system 200.

Based on an inquiry about one or more vehicles of interest from a consumer, the one or more models 240 may generate a list of comprehensive vehicle quotes. The one or more models 240 may determine a likelihood of closing for each comprehensive vehicle quote. The one or more models 240 may rank each comprehensive vehicle quote based the determined likelihood of closing. In some embodiments, the one or more models 240 may rank or grade the comprehensive vehicle quotes on a predefined ranking range. The predefined ranking range may include a numerical ranking (e.g., 1 to 5, 1 to 10), a letter ranking (e.g., A, B, C, D, E, F, etc.), a ranking based on a likelihood of closing (e.g., highest likelihood to lowest likelihood), and/or other ranking ranges.

In some embodiments, the machine learning engine 244 may include instructions that direct and/or cause the vehicle quote system 220 to predict one or more comprehensive vehicle quotes. The one or more comprehensive vehicle quotes may comprise a high likelihood of closing based on the received data from a consumer. The machine learning engine 244 may include instructions that direct and/or cause the vehicle quote system 220 to use predictive analytics to determine a ranked list of comprehensive vehicle quotes that include a high likelihood of closing based on the parameters associated with a consumer. Further, the one or more models 240 may generate an available recommendation to close on one of the one or more comprehensive vehicle quotes on the ranked list. The ranked list of comprehensive vehicle quotes may include one, two, three, four, five, etc. comprehensive vehicle quotes. The machine learning engine 244 may set, define, and/or iteratively refine optimization rules, techniques, and/or other parameters used by the vehicle quote system 220 and/or other computing systems in the vehicle quote determination and analysis system 200.

The machine learning engine 244 may train the one or more models 240 using one or more tools, received data from one or more computing systems of the vehicle quote determination and analysis system 200, and the historical data stored in the historical database 216 as described above. The one or more tools may include decision trees, support vector machines, random forests, k-means algorithms, gradient boosting algorithms, gradient boosted tree model algorithms, dimensionality reduction algorithms, supervised learning algorithms, unsupervised learning algorithms, regression algorithms (e.g., linear regressions, logistic regression, and the like), instance based algorithms (e.g., learning vector quantization, locally weighted learning, and the like), regularization algorithms (e.g., ridge regression, least-angle regression, and the like), decision tress algorithms, Bayesian algorithms, clustering algorithms, artificial neutral network algorithms, and the like. The machine learning engine 348 may utilize other algorithms, and/or other machine learning algorithms without departing from the disclosure such as large language models or small language models. In embodiments, the vehicle quote system 220 may be in communication with one or more machine learning models, agentic artificial intelligence tools, and/or other artificial intelligence tools.

In embodiments, the machine learning engine 244 may train the one or more models 240 based on the historical data using positive and negative cases. In embodiments, the machine learning engine 244 may create positive cases comprising one or more comprehensive vehicle quotes that resulted in acceptance or closure by one or more consumers. In embodiments, the machine learning engine 244 may create negative cases comprising one or more comprehensive vehicle quotes that resulted in rejection, no acceptance, or not closing by one or more consumers. The machine learning engine 244 may be trained to distinguish between the positive and negative cases to generate one or more comprehensive vehicle quotes for future consumers. In embodiments, an output of the one or more models 240 may form as additional training data for the one or more models 240 to generate subsequent comprehensive vehicle quotes for subsequent consumers seeking to receive one or more comprehensive vehicle quotes.

For example, the one or more models 240 may be trained to recommend vehicles to a consumer based on a vehicle cost and/or a vehicle condition while predicting future costs as the vehicle ages. The trained one or more models 240 may provide one or more comprehensive vehicle quotes that go beyond an original inquiry by a consumer, but still meets the consumer’s budgetary requirements. In embodiments, where a consumer only purchases a particular vehicle model or price point, the one or more models 240 may provide a comprehensive vehicle quote for a plurality of vehicles which may include one or more vehicle models (e.g., SUV, truck, crossover, sedan, etc.). In these embodiments, the one or more models 240 may recommend a comprehensive vehicle quote comprising a vehicle model and the associated price point that may be different than an original inquiry by the consumer. The consumer may view comprehensive vehicle quotes for a plurality of vehicle models that meet a predetermined budgetary requirement set by the consumer.

In other embodiments, the vehicle quote system 220 may utilize an artificial intelligence assistance (i.e., A.I. assistant) to generate the one or more comprehensive vehicle quotes for a consumer. In some embodiments, the vehicle quote system 220 may generate an available recommendation to close on one of the one or more comprehensive vehicle quotes on the ranked list using generative artificial intelligence or an artificial intelligence assistant (e.g., A.I. assistant).

In some embodiments, the machine learning engine 244 may train the one or more models 240 using one or more generative artificial intelligence tools, or the one or more models 240 may be generative artificial intelligence models. For example, the one or more models 240 may include a text-to-text language model or large language model (LLM). The one or more models 240 may include a neutral network, and/or other machine learning algorithms. The generative artificial intelligence models may analyze data received by the computing systems of the vehicle quote and determination system 200 by performing techniques including prompt engineering, multimodal analysis, other machine learning techniques, and/or other techniques. For example, in performing prompt engineering, the vehicle quote system 220 may receive a prompt including natural language text for use by the one or more models 240 to generate an output.

In some embodiments, the one or more models 240 may be trained or generated for one or more states, one or more regions. In other embodiments, the one or more models 240 may comprise a multi-state model that accommodate rules, regulations, vehicle costs, finance and insurance product costs, and other total costs of vehicle ownership considerations for a plurality of states. The one or more models 240 may accommodate the rules, regulations, vehicle costs, finance and insurance product costs, and other total cost of vehicle ownership considerations for one or more states, or one or more regions. For example, the vehicle quote system 220 may comprise a first model 240 for a first state, and a second model for a second state, where the first state is different than the second state. For example, the vehicle quote system 220 may comprise a multi-state model that comprises a plurality of states in a region such as the East, Midwest, Southwest, South, or West of the United States of America.

The DMS 204, the enterprise system 208, the historical database 216, the mobile computing device 212, and the vehicle quote system 220 may be separate elements. In other embodiments, the DMS 204, the enterprise system 208, the historical database 232, the mobile computing device 212, and the vehicle quote system 220 may be within the same structure in accordance with aspects of the present disclosure.

### Determining Comprehensive Vehicle Quotes

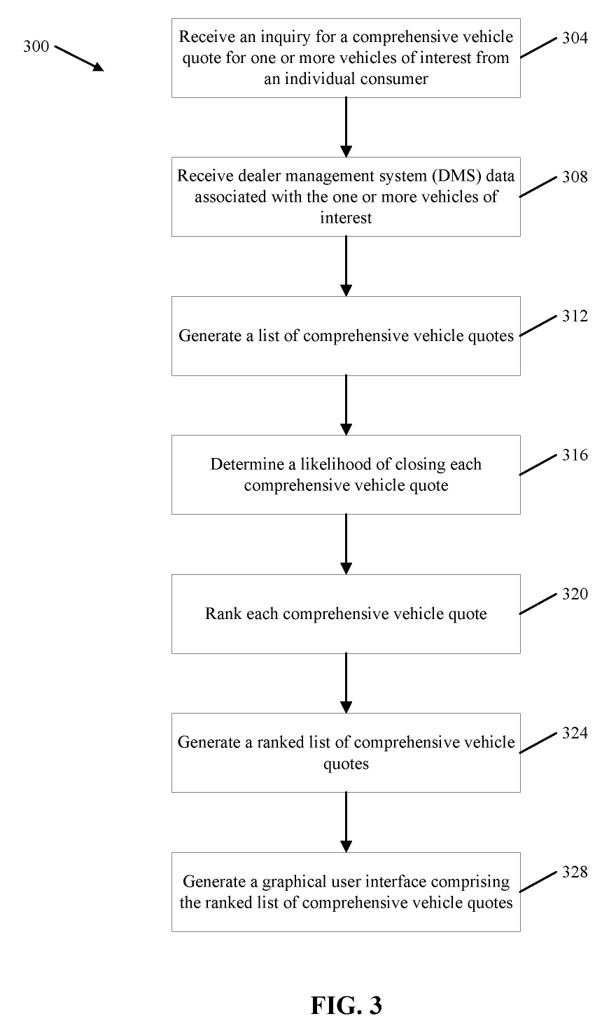

FIG. 3 is a flow chart illustrating a method 300 (or process 300) for determining one or more comprehensive vehicle quotes requested by a consumer according to one or more embodiments. Some or all of the steps of method 300 may be performed using one or more computing devices, one or more computing systems, and/or combinations thereof of the vehicle quote determination and analysis system 200. In a variety of embodiments, some or all of the steps described below may be combined and/or divided into sub-steps as appropriate.

Referring to FIG. 3, at step 304, the vehicle quote system 220 may receive an inquiry for a comprehensive vehicle quote for one or more vehicles of interest from a consumer. In some embodiments, the vehicle quote system 220 may receive the inquiry for the comprehensive vehicle quote from the mobile computing device 212 associated with the consumer over the network 160. For example, the comprehensive vehicle quote may include a vehicle cost quote and the associated quotes for finance and insurance (F&I) products. In some embodiments, the comprehensive vehicle quote may include a quote for the vehicle cost, the vehicle loan cost, and/or the insurance policy cost.

The vehicle quote system 220 may request information from the consumer such as details on the vehicles of interest (e.g., make, model, year, etc.), details on the vehicle loan (e.g., loan duration, budget, annual percentage rate), number of miles driven, average or preferred length of vehicle ownership, and/or details on the insurance policy (e.g., auto insurance policy, duration, coverage amount, etc.). The vehicle quote system 220 may receive information associated with the consumer from the enterprise system 208. For example, the consumer may have an insurance policy at the enterprise system 208, where the enterprise system 208 may be associated with an insurance company. The vehicle quote system 220 may receive the information from the consumer via a graphical user interface, a form, one or more input fields that may generated on the mobile computing device 212 or other computing devices associated with the consumer.

At step 308, the vehicle quote system 220 may receive dealer management system (DMS) data associated with the one or more vehicles of interest from a dealership. For example, the vehicle quote system 220 may send a request to the DMS 204 for dealer management data (DMS data) associated with the one or more vehicles of interest. For example, the DMS data may include a make, model, year, usage status (e.g., used or new), etc. for each vehicle of interest. In some embodiments, the DMS data may be associated with a preferred dealership requested by the consumer. In other embodiments, the DMS data may be associated with one or more different dealerships. For example, the vehicle quote system 220 may receive DMS data from one or more dealerships comprising a preferred dealership by the consumer, and other dealerships offering vehicles of interest relevant to the inquiry requested by the consumer.

At step 312, the vehicle quote system 220 may generate a list of comprehensive vehicle quotes (e.g., comprehensive vehicle quote 500 of FIG. 6). The vehicle quote system 220 may use the one or more models 240 to generate the list of comprehensive vehicle quotes. For example, the one or more models 240 may use the consumer information received at step 304, and the DMS data as an input. The one or more models 240 may be trained by the machine learning engine 244 to generate the list of comprehensive vehicle quotes. For example, the one or more models 240 may determine the one or more vehicles of interest, and the associated finance and insurance products that may be relevant to the consumer. For example, the one or more models 240 may provide comprehensive vehicle quote comprising the vehicles of interest, the vehicle loan details, auto insurance policy details, and/or other details that contribute to a total cost of owning the vehicles of interest.

At step 316, the vehicle quote system 220 may determine a likelihood of closing each comprehensive vehicle quote using the one or more models 240. The one or more models 240 may use predictive analytics to determine the likelihood of closing each comprehensive vehicle quote. The one or more models 240 may consider factors such as the received consumer information, the DMS data, and/or historical data associated with the consumer such as historical vehicles and historical insurance policies to determine the likelihood of closing the comprehensive vehicle quotes.

At step 320, the vehicle quote system 220 may rank each comprehensive vehicle quote. The vehicle quote system 220 may rank each comprehensive vehicle quote on a predefined ranking range. The predefined ranking range may include a numerical range (e.g., 1 to 5), a letter range (e.g., A to D), or other types of ranges. For example, the vehicle quote system 220 may rank each comprehensive vehicle quote based on the likelihood of closing (e.g., highest likelihood of closing to lowest likelihood of closing). In embodiments, the vehicle quote system 220 may rank each comprehensive vehicle quote based on the likelihood of acceptance by a consumer.

At step 324, the vehicle quote system 220 may generate a ranked list of comprehensive vehicle quotes. The vehicle quote system 220 may generate the ranked list of comprehensive vehicle quotes based on the relative rankings of each vehicle quote. In some embodiments, based on received consumer data and/or the DMS data which may include structured or unstructured data, the vehicle quote system 220 may generate ranked data that comprises the ranked list of comprehensive vehicle quotes. In other words, the one or more models 240 may receive consumer data and/or DMS data as an input, and convert or transform the multiple types of data into data that is capable of being ranked (i.e., ranked data). In some embodiments, the one or more models 240 may receive data from one or more computing systems of the vehicle quote determination and analysis system 200 in one or more data formats as an input, and convert the one or more data formats into data that is capable of being ranked according to an aspect associated with the comprehensive vehicle quote (e.g., vehicle cost, insurance policy cost, vehicle loan cost, service event cost, maintenance event cost, etc.). In embodiments, the one or more models 240 may receive data from the one or more computing systems of the vehicle quote determination and analysis system 200 in one or more data formats as an input, and convert the one or more data formats into a standardized format such that one or more comprehensive vehicle quotes may be ranked and/or compared.

At step 328, the vehicle quote system 220 may generate or include instructions to generate a graphical user interface comprising the ranked list of comprehensive vehicle quotes. In embodiments, the enterprise computing device 236 and/or the mobile computing device 212 may comprise a graphical user interface including the ranked list of comprehensive vehicle quotes. In embodiments, the vehicle quote system 220 may send the ranked list of comprehensive vehicle quotes (i.e., ranked data) to other computing devices in the vehicle quote determination and analysis system 200 for display and/or analysis. Additionally or alternatively, the vehicle quote system 220 may transmit the ranked list of vehicle quotes to one or more of the enterprise system 208 (e.g., enterprise computing device 236), or the mobile computing device 212. In embodiments, the vehicle quote system 220 may transmit one or more comprehensive vehicle quotes to a computing device (e.g., mobile computing device 212) associated with a consumer based a determination that a likelihood of acceptance is above a threshold.

Additionally or alternatively, at step 328, the vehicle quote system 220 may generate a graphical user interface including one or more comprehensive vehicle quotes, wherein one or more aspects for the one or more comprehensive vehicle quotes may be modifiable. In embodiments, the graphical user interface may include selectable button(s), drop down(s), check box(s), radio button(s) configured to receive one or more inputs from a consumer using the graphical user interface. The consumer may modify one or more aspects of the one or more comprehensive vehicle quotes. The modifications to the comprehensive vehicle quote(s) may be transmitted to the vehicle quote system 220 for processing, and generation of one or more updated comprehensive vehicle quotes.

It should be understood that the method 300 of FIG. 3 is an example and that other methods with similar steps are contemplated. In such other methods, additional steps may be included, or steps may be omitted. Also, other methods may change the order of any of the steps. Further, the method 300 of FIG. 3 may occur at any period of time before, during, after purchasing a vehicle of interest. For example, the method 300 of FIG. 3 may occur over an entire lifecycle of a consumer purchasing, maintaining, and selling a vehicle of interest. For example, the vehicle quote system 220 may generate one or more comprehensive vehicle quotes for a consumer during the occurrence of a vehicle maintenance event, a vehicle or vehicle part recall, a vehicle collision event, a vehicle repair event, a change in vehicle repair provider, a change in insurance provider, a change of vehicle loan provider, or any vehicle event that affects to vehicle ownership costs, etc.

In other embodiments, the method 300 of FIG. 3 may occur in real-time as vehicle related events may trigger the need for a consumer to understand the total cost of vehicle ownership. Still, in other embodiments, the method 300 of FIG. 3 may operate multiple times to compare and/or contrast a plurality of vehicles and/or a plurality of finance and insurance products. For example, a consumer may request a first comprehensive vehicle quote using the method 300 of FIG. 3 for their current vehicle, and a second comprehensive vehicle quote using the method 300 of FIG. 3 for a new vehicle of interest (e.g., new vehicle or trade-in vehicle). The consumer may compare the first comprehensive vehicle quote and the second comprehensive vehicle quote.

### Determining Comprehensive Vehicle Quotes using Machine Learning Techniques

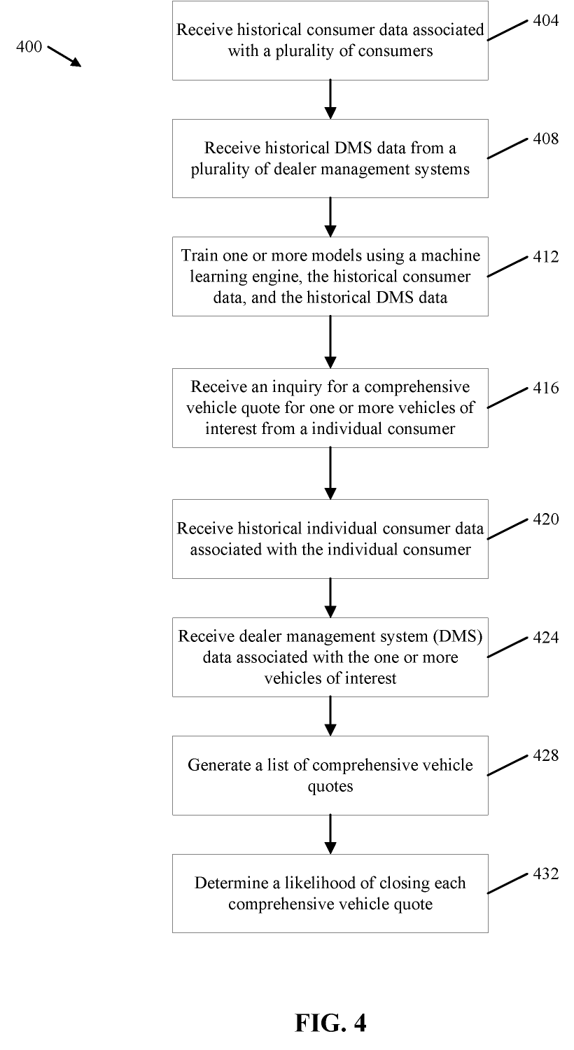

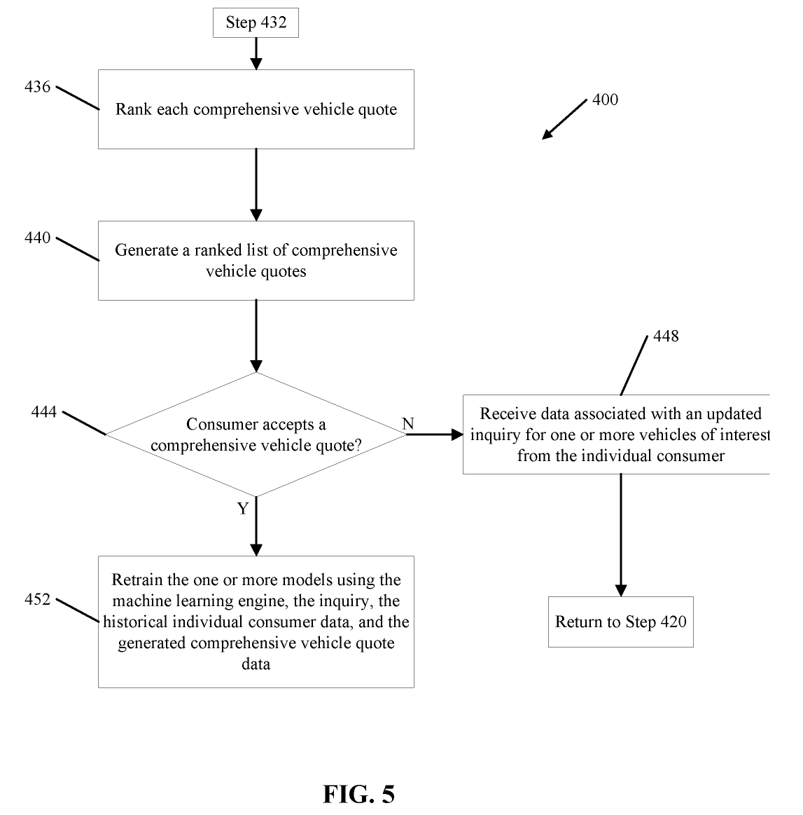

FIGS. 4 and 5 is a flow chart illustrating a method 400 (or process 400) for determining a comprehensive vehicle quote requested by an consumer using machine learning techniques according to one or more embodiments. Some or all the steps of method 400 may be performed using one or more computing devices and/or any combination thereof of the vehicle quote determination and analysis system 200. In a variety of embodiments, some or all of the steps described below may be combined and/or divided into sub-steps as appropriate. Further, some or all of the steps of method 400 in FIGS. 4 and 5 may be performed with method 300 in FIG. 3 described above.

Referring to FIG. 4, at step 404, the vehicle quote system 220 may receive historical data (e.g., historical database 216 of FIG. 2) associated with a plurality of consumers. The plurality of consumers may also be referred to as a plurality of historical consumers. The historical data received from the plurality of consumers may correspond to one or more vehicles, and the associated finance and insurance (F&I) products purchased by the plurality of consumers. The vehicle quote system 220 may receive historical information associated with a plurality of consumers from the enterprise system 208. For example, the historical data may include a vehicle, an insurance policy, a vehicle loan, and/or other vehicle products that contribute to a total cost of owning a vehicle.

At step 408, the vehicle quote system 220 may receive historical data from a plurality of dealer management systems 204. The plurality of dealer management systems 204 may be associated with a plurality of dealerships that offer one or more vehicles and/or vehicle services. The historical data from the plurality of dealer management systems 204 may correspond to a plurality of vehicles, vehicle services, vehicle parts, etc. For example, the historical data received from the plurality of dealer management systems 204 may include one or more vehicles purchased by the plurality of consumers.

At step 412, the vehicle quote system 220 may train the one or more models 240 using the machine learning engine 244, the historical consumer data received at step 404, and the historical DMS data received at step 408. The vehicle quote system 220 may train the one or more models 240 to output comprehensive vehicle quotes that have a high likelihood of closing for new consumers. The comprehensive vehicle quotes may output one or more vehicles, and the associated finance and insurance (F&I) products that have a high likelihood of being accepted or closed by the new consumers. The vehicle quote system 220 may train the one or more models 240 using the one or more tools as described in this disclosure. In embodiments, the vehicle quote system 220 may train the one or more models 240 using positive cases comprising comprehensive vehicle quotes that were accepted or closed by historical consumers. In embodiments, the vehicle quote system 220 may train the one or more models 240 using negative cases comprising comprehensive vehicle quotes that were not accepted or closed by historical consumers.

At step 416, the vehicle quote system 220 may receive an inquiry for a comprehensive vehicle quote. The inquiry may include a comprehensive vehicle quote for one or more vehicles of interest offered by a dealership selected by a consumer. The inquiry may include providing information for one or more vehicles of interest, and the associated finance and insurance (F&I) products such as insurance policies and/or vehicle loans. In some embodiments, the consumer may request for the inquiry through an application running on the mobile computing device 212. For example, the application may be offered by an insurance company offering one or more insurance products. In other embodiments, the consumer may request for the inquiry for the comprehensive vehicle quote at a dealership. The vehicle quote system 220 may request information from the consumer such as details on the vehicles of interest (e.g., make, model, year, etc.), details on the vehicle loan (e.g., loan duration, budget, annual percentage rate), and/or details on the insurance policy (e.g., auto insurance policy, duration, coverage amount, etc.). The vehicle quote system 220 may receive the information from the consumer via a graphical user interface, a form, one or more input fields that may generated on the mobile computing device 212 or other computing devices associated with the consumer.

At step 420, the vehicle quote system 220 may receive historical consumer data associated with the consumer making the inquiry for the comprehensive vehicle quote (e.g., step 416). For example, the historical consumer data may include historical vehicles and/or finance and insurance (F&I) products purchased by the consumer. The historical consumer data may be used as additional training data for the one or more models.

At step 424, the vehicle quote system 220 may receive DMS data corresponding to the one or more vehicles of interest from the DMS 204. In some embodiments, the consumer, when requesting the inquiry at step 416, may request a dealership that offers the one or more vehicles of interest. For example, the DMS data may include details such as make, model, and year for the one or more vehicles of interest.

At step 428, the vehicle quote system 220 may generate a list of comprehensive of vehicle quotes (e.g., comprehensive vehicle quote 500 of FIG. 6). The vehicle quote system 220 may use to the one or more models 240 to output the list of comprehensive vehicle quotes that would result in a high acceptance or closure by the consumer.

At step 432, the vehicle quote system 220 may determine a likelihood of closing each comprehensive vehicle quote on the list of comprehensive of vehicle quotes. The vehicle quote system may use the one or more models 240, the historical consumer data, the historical DMS data, the historical consumer data, and/or combinations thereof to determine the likelihood of closing each comprehensive vehicle quote.

Referring to FIG. 5, at step 436, the vehicle quote system 220 may rank each comprehensive vehicle quote. In some embodiments, the vehicle quote system 220 may use the one or more models 240 to rank the comprehensive vehicles quotes on the list of comprehensive vehicle quotes on a predefined ranking range. For example, the predefined ranking range may include a ranking from highest likelihood of closing to the lowest likelihood of closing. For example, the predefined ranking range may be a numerical range or letter range ranking the comprehensive vehicle quotes by the consumer’s preferences and/or budget. The one or more models 240 may receive the historical data associated with a plurality of previous consumers, the historical DMS data, the data associated with the inquiry, the historical consumer data associated with the consumer making the inquiry, and the current DMS data which may include structured data (e.g., data tables, labelled data), unstructured data (e.g., text files, surveys), and/or other types of data (e.g., images) as an input. With the received data, the one or more models 240 may generate data that may be capable of being ranked and provided to the consumer.

As shown in FIG. 5, at step 440, the vehicle quote system 220 may generate a ranked list of comprehensive vehicle quotes. In some embodiments, the vehicle quote system 220 may generate the ranked list of comprehensive vehicle quotes on a graphical user interface of the enterprise computing device 236, the DMS computing device 228, and/or the mobile computing device 212. In embodiments, the vehicle quote system 220 may generate the ranked list of comprehensive vehicle quotes as a file that may be sent to one or more of the DMS system 204, the enterprise system 208, the historical database 216, and/or the mobile computing device 212. In embodiments, the vehicle quote system 220 may generate the ranked list of comprehensive vehicle quotes as data that may be used by the computing systems of the vehicle quote determination and analysis system 200 (e.g., storage, transfer, display, additional training data for the one or more models 240).

At step 444, the vehicle quote system 220 may determine whether the consumer has accepted or closed on one of the comprehensive vehicle quotes on the ranked list of comprehensive vehicle quotes. If the vehicle quote system 220 determines the consumer does not accept or close on one of the comprehensive vehicle quotes on the ranked list of comprehensive vehicle quotes, then at step 448, the vehicle quote system 200 may receive data associated with an updated inquiry for one or more comprehensive vehicle quotes from the consumer. The vehicle quote system 220 may continue to operate and repeat steps 420, 424, 428, 432, 436, 440, 448 as additional current or real-time data continues to be received from the consumer, the enterprise system 208, and/or the DMS 204. The vehicle quote system 220 may continue to generate updated or new comprehensive vehicle quotes based on the received current or real-time data provided by the consumer, the enterprise system 208, and/or the DMS 204. The vehicle quote system 220 may continue to operate until the consumer accepts or closes on one of the comprehensive vehicle quotes on the ranked list of comprehensive vehicle quotes.

With continued reference to FIG. 5, if the vehicle quote system 220 determines the consumer accepts or closes on one of the comprehensive vehicle quotes on the ranked list of comprehensive vehicle quotes, then at step 452, the vehicle quote system 220 may utilize the generated data such as comprehensive vehicle quotes, ranking of the comprehensive vehicle quotes as additional training data for the one or more models 240. The vehicle quote system 220 may retrain the one or more models using the machine learning engine 244 to determine comprehensive vehicle quotes for future consumers interested in purchasing a new or used vehicle from a dealership.

It should be understood that the method 400 of FIGS. 4 and 5 is an example and that other methods with similar steps are contemplated. In such other methods, additional steps may be included or steps may be omitted. Also, other methods may change the order of any of the steps. Further, the method 400 of FIGS. 4 and 5 may occur at any period of time before, during, after purchasing a vehicle of interest. For example, the method 400 of FIGS. 4 and 5 may occur over an entire lifecycle of a consumer purchasing, maintaining, and selling a vehicle of interest. For example, the vehicle quote system 200 may generate one or more comprehensive vehicle quotes for a consumer during the occurrence of a vehicle maintenance event, a vehicle or vehicle part recall, a vehicle collision event, a vehicle repair event, a change in vehicle repair provider, a change in insurance provider, a change of vehicle loan provider, or any vehicle event that affects to vehicle ownership costs, etc. In other embodiments, the method 400 of FIGS. 4 and 5 may occur in real-time as vehicle related events may trigger the need for a consumer to understand the total cost of vehicle ownership. Still, in other embodiments, the method 400 of FIGS. 4 and 5 may operate multiple times to compare and/or contrast a plurality of vehicles and/or a plurality of finance and insurance products.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

For the purposes of describing and defining the present disclosure, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is noted that recitations herein of “at least one” component, element, etc., should not be used to create an inference that the alternative use of articles “a” or “an” should be limited to a single component, element, etc. It is further noted that recitations herein of “a”, “an”, “the”, “at least one”, and “one or more” are used interchangeably to indicate that at least one of the item is present and a plurality of such items may be present unless the context clearly indicates otherwise. It is also noted that recitations herein of a component of the present disclosure being “configured” or “programed” in a particular way, to embody a particular property, or to function in a particular manner, are structural recitations, as opposed to recitations of intended use.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilized the term “wherein” as a transitional phrase. For the purposes of defining the present disclosure, it noted that his term is an open-ended transitional term that is used to introduce a recitation of a series of characteristics of the structure and should be interpreted in like manner as the more commonly used open-ended preamble term “comprising.”

### Representative Features

Representative features are set out in the following clauses, which stand alone or may be combined, in any combination, with one or more features disclosed in the text and/or drawings of the specification.

Clause 1. A system comprising: at least one processor; a communication interface communicatively coupled to the at least one processor; and memory storing computer-readable instructions that, when executed by the at least one processor, cause the at least one processor to: receive an inquiry from a consumer regarding at least one vehicle of interest; collect cost-related data from one or more sources associated with the least one vehicle of interest, wherein the cost-related data corresponds to a vehicle ownership cost over a lifecycle of vehicle ownership; generate, using at least one machine learning model, a comprehensive vehicle quote comprising a total cost of vehicle ownership for the at least one vehicle of interest, wherein the comprehensive vehicle quote includes one or more of a vehicle purchase cost, a vehicle policy cost, or the vehicle ownership cost over the lifecycle of vehicle ownership; determine, using the at least one machine learning model, a likelihood of acceptance that the consumer accepts the comprehensive vehicle quote; and transmit, based on a determination that the likelihood of acceptance is above a threshold, the comprehensive vehicle quote to a computing device associated with the consumer.

Clause 2. The system of Clause 1, further comprising memory storing computer-readable instructions that, when executed by the at least one processor, cause the at least one processor to: detect a vehicle event during the lifecycle of vehicle ownership, wherein the vehicle event includes at least one of a vehicle maintenance event or a warranty expiration event; generate, based on the detection of the vehicle event, an updated comprehensive vehicle quote including one or more updated parameters associated with the total cost of vehicle ownership; and transmit the updated comprehensive vehicle quote to the computing device.

Clause 3. The system of any of Clause 1 to Clause 2, further comprising memory storing computer-readable instructions that, when executed by the at least one processor, cause the at least one processor to: monitor data associated with the at least one vehicle of interest from one or more of a dealer management system, an external database, or an enterprise system; detect a change in cost associated with the at least one vehicle of interest, wherein the change in cost includes a vehicle cost, a vehicle policy cost, or a vehicle maintenance cost; and transmit an updated comprehensive vehicle quote to the computing device.

Clause 4. The system of any of Clause 1 to Clause 3, further comprising memory storing computer-readable instructions that, when executed by the at least one processor, cause the at least one processor to: present, via a graphical user interface of the computing device, the comprehensive vehicle quote; and generate, via the graphical user interface, one or more modifiable aspects of the comprehensive vehicle quote, wherein the comprehensive vehicle quote is modifiable via one or more inputs using the graphical user interface.

Clause 5. The system of any of Clause 1 to Clause 4, wherein the one or more sources include dealer management system data indicative of transactional data relating to the at least one vehicle of interest, and enterprise data indicative of policy data associated with the at least one vehicle of interest.

Clause 6. The system of any of Clause 1 to Clause 5, further comprising memory storing computer-readable instructions that, when executed by the at least one processor, cause the at least one processor to: receive, from one or more databases, historical data associated with the consumer, wherein the historical data includes one or more of a purchased vehicle, a vehicle policy, or a vehicle maintenance cost; predict, via the machine learning model and based on the historical data, one or more aspects of the comprehensive vehicle quote, wherein the one or more aspects include one or more of the vehicle purchase cost, the vehicle policy cost, or the vehicle ownership cost over the lifecycle of vehicle ownership; and generate, via the machine learning model, the comprehensive vehicle quote including the one or more aspects.

Clause 7. The system of any of Clause 1 to Clause 6, further comprising memory storing computer-readable instructions that, when executed by the at least one processor, cause the at least one processor to: selectively transmit, via a network, different portions of the ranked list of comprehensive vehicle quotes to one or more remote computing devices, wherein a subset of comprehensive vehicle quotes on the ranked list of comprehensive vehicle quotes characterized by the likelihood of acceptance above a threshold are initially transmitted to the one or more remote computing devices.

Clause 8. A method comprising: receiving an inquiry from a consumer regarding at least one vehicle of interest; collecting cost-related data from one or more sources associated with the least one vehicle of interest, wherein the cost-related data corresponds to a vehicle ownership cost over a lifecycle of vehicle ownership; generating, using at least one machine learning model, a comprehensive vehicle quote comprising a total cost of vehicle ownership for the at least one vehicle of interest, wherein the comprehensive vehicle quote includes one or more of a vehicle purchase cost, a vehicle policy cost, or the vehicle ownership cost over the lifecycle of vehicle ownership; determining, using the at least one machine learning model, a likelihood of acceptance that the consumer accepts the comprehensive vehicle quote; and transmitting, based on a determination that the likelihood of acceptance is above a threshold, the comprehensive vehicle quote to a computing device associated with the consumer.

Clause 9. The method of Clause 8, further comprising: detecting a vehicle event during the lifecycle of vehicle ownership, wherein the vehicle event includes at least one of a vehicle maintenance event or a warranty expiration event; generating, based on the detection of the vehicle event, an updated comprehensive vehicle quote including one or more updated parameters associated with the total cost of vehicle ownership; and transmitting the updated comprehensive vehicle quote to the computing device.

Clause 10. The method of any of Clause 8 to Clause 9, further comprising: monitoring data associated with the at least one vehicle of interest from one or more of a dealer management system, an external database, or an enterprise system; detecting a change in cost associated with the at least one vehicle of interest, wherein the change in cost includes a vehicle cost, a vehicle policy cost, or a vehicle maintenance cost; and transmitting an updated comprehensive vehicle quote to the computing device.

Clause 11. The method of any of Clause 8 to Clause 10, further comprising: presenting, via a graphical user interface of the computing device, the comprehensive vehicle quote; and generating, via the graphical user interface, one or more modifiable aspects of the comprehensive vehicle quote, wherein the comprehensive vehicle quote is modifiable via one or more inputs using the graphical user interface.

Clause 12. The method of any of Clause 8 to Clause 11, wherein the one or more sources include dealer management system data indicative of transactional data relating to the at least one vehicle of interest, and enterprise data indicative of policy data associated with the at least one vehicle of interest.

Clause 13. The method of any of Clause 8 to Clause 12, further comprising: receiving, from one or more databases, historical data associated with the consumer, wherein the historical data includes one or more of a purchased vehicle, a vehicle policy, or a vehicle maintenance cost; predicting, via the machine learning model and based on the historical data, one or more aspects of the comprehensive vehicle quote, wherein the one or more aspects include one or more of the vehicle purchase cost, the vehicle policy cost, or the vehicle ownership cost over the lifecycle of vehicle ownership; and generating, via the machine learning model, the comprehensive vehicle quote including the one or more aspects.

Clause 14. The method of any of Clause 8 to Clause 13, further comprising memory storing computer-readable instructions that, when executed by the at least one processor, cause the at least one processor to: selectively transmit, via a network, different portions of the ranked list of comprehensive vehicle quotes to one or more remote computing devices, wherein a subset of comprehensive vehicle quotes on the ranked list of comprehensive vehicle quotes characterized by the likelihood of acceptance above a threshold are initially transmitted to the one or more remote computing devices.

Clause 15. One or more non-transitory computer-readable media storing instructions that, when executed by a processor, cause the processor to: receive an inquiry from a consumer regarding at least one vehicle of interest; collect cost-related data from one or more sources associated with the least one vehicle of interest, wherein the cost-related data corresponds to a vehicle ownership cost over a lifecycle of vehicle ownership; generate, using at least one machine learning model, a comprehensive vehicle quote comprising a total cost of vehicle ownership for the at least one vehicle of interest, wherein the comprehensive vehicle quote includes one or more of a vehicle purchase cost, a vehicle policy cost, or the vehicle ownership cost over the lifecycle of vehicle ownership; determine, using the at least one machine learning model, a likelihood of acceptance that the consumer accepts the comprehensive vehicle quote; and transmit, based on a determination that the likelihood of acceptance is above a threshold, the comprehensive vehicle quote to a computing device associated with the consumer.

Clause 16. The non-transitory computer-readable media storing instructions of Clause 15, wherein when executed by the processor, cause the processor to: detect a vehicle event during the lifecycle of vehicle ownership, wherein the vehicle event includes at least one of a vehicle maintenance event or a warranty expiration event; generate, based on the detection of the vehicle event, an updated comprehensive vehicle quote including one or more updated parameters associated with the total cost of vehicle ownership; and transmit the updated comprehensive vehicle quote to the computing device.

Clause 17. The non-transitory computer-readable media storing instructions of any of Clause 15 to Clause 16, wherein when executed by the processor, cause the processor to: monitor data associated with the at least one vehicle of interest from one or more of a dealer management system, an external database, or an enterprise system; detect a change in cost associated with the at least one vehicle of interest, wherein the change in cost includes a vehicle cost, a vehicle policy cost, or a vehicle maintenance cost; and transmit an updated comprehensive vehicle quote to the computing device.

Clause 18. The non-transitory computer-readable media storing instructions of any of Clause 15 to Clause 17, wherein when executed by the processor, cause the processor to: present, via a graphical user interface of the computing device, the comprehensive vehicle quote; and generate, via the graphical user interface, one or more modifiable aspects of the comprehensive vehicle quote, wherein the comprehensive vehicle quote is modifiable via one or more inputs using the graphical user interface.

Clause 19. The non-transitory computer-readable media storing instructions of any of Clause 15 to Clause 18, wherein when executed by the processor, cause the processor to: receive, from one or more databases, historical data associated with the consumer, wherein the historical data includes one or more of a purchased vehicle, a vehicle policy, or a vehicle maintenance cost; predict, via the machine learning model and based on the historical data, one or more aspects of the comprehensive vehicle quote, wherein the one or more aspects include one or more of the vehicle purchase cost, the vehicle policy cost, or the vehicle ownership cost over the lifecycle of vehicle ownership; and generate, via the machine learning model, the comprehensive vehicle quote including the one or more aspects.

Clause 20. The non-transitory computer-readable media storing instructions of any of Clause 15 to Clause 19, wherein when executed by the processor, cause the processor to: selectively transmit, via a network, different portions of the ranked list of comprehensive vehicle quotes to one or more remote computing devices, wherein a subset of comprehensive vehicle quotes on the ranked list of comprehensive vehicle quotes characterized by the likelihood of acceptance above a threshold are initially transmitted to the one or more remote computing devices.

Aspects of the disclosure have been described in terms of illustrative embodiment thereof. Numerous other embodiments, modifications, and variations within the scope and spirit of the appended claims will occur to persons of ordinary skill in the art from a review of this disclosure. For example, one or more steps depicted in the illustrative figures may be performed in a different order other than the recited order, and one or more depicted steps may be optional in accordance with aspects of the disclosure.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system comprising:
at least one processor;
a communication interface communicatively coupled to the at least one processor; and
memory storing computer-readable instructions that, when executed by the at least one processor, cause the at least one processor to:
receive an inquiry from a consumer regarding at least one vehicle of interest;
collect cost-related data from one or more sources associated with the least one vehicle of interest, wherein the cost-related data corresponds to a vehicle ownership cost over a lifecycle of vehicle ownership;
generate, using at least one machine learning model, a comprehensive vehicle quote comprising a total cost of vehicle ownership for the at least one vehicle of interest, wherein the comprehensive vehicle quote includes one or more of a vehicle purchase cost, a vehicle policy cost, or the vehicle ownership cost over the lifecycle of vehicle ownership;
determine, using the at least one machine learning model, a likelihood of acceptance that the consumer accepts the comprehensive vehicle quote; and
transmit, based on a determination that the likelihood of acceptance is above a threshold, the comprehensive vehicle quote to a computing device associated with the consumer.

2. The system of claim 1, further comprising memory storing computer-readable instructions that, when executed by the at least one processor, cause the at least one processor to:
detect a vehicle event during the lifecycle of vehicle ownership, wherein the vehicle event includes at least one of a vehicle maintenance event or a warranty expiration event;
generate, based on the detection of the vehicle event, an updated comprehensive vehicle quote including one or more updated parameters associated with the total cost of vehicle ownership; and
transmit the updated comprehensive vehicle quote to the computing device.

3. The system of claim 1, further comprising memory storing computer-readable instructions that, when executed by the at least one processor, cause the at least one processor to:
monitor data associated with the at least one vehicle of interest from one or more of a dealer management system, an external database, or an enterprise system;
detect a change in cost associated with the least one vehicle of interest, wherein the change in cost includes a vehicle cost, a vehicle policy cost, or a vehicle maintenance cost; and
transmit an updated comprehensive vehicle quote to the computing device.

4. The system of claim 1, further comprising memory storing computer-readable instructions that, when executed by the at least one processor, cause the at least one processor to:
present, via a graphical user interface of the computing device, the comprehensive vehicle quote; and
generate, via the graphical user interface, one or more modifiable aspects of the comprehensive vehicle quote, wherein the comprehensive vehicle quote is modifiable via one or more inputs using the graphical user interface.

5. The system of claim 1, wherein the one or more sources include dealer management system data indicative of transactional data relating to the at least one vehicle of interest, and enterprise data indicative of policy data associated with the at least one vehicle of interest.

6. The system of claim 1, further comprising memory storing computer-readable instructions that, when executed by the at least one processor, cause the at least one processor to:
receive, from one or more databases, historical data associated with the consumer, wherein the historical data includes one or more of a purchased vehicle, a vehicle policy, or a vehicle maintenance cost;
predict, via the machine learning model and based on the historical data, one or more aspects of the comprehensive vehicle quote, wherein the one or more aspects include one or more of the vehicle purchase cost, the vehicle policy cost, or the vehicle ownership cost over the lifecycle of vehicle ownership; and
generate, via the machine learning model, the comprehensive vehicle quote including the one or more aspects.

7. The system of claim 6, further comprising memory storing computer-readable instructions that, when executed by the at least one processor, cause the at least one processor to:
selectively transmit, via a network, different portions of the ranked list of comprehensive vehicle quotes to one or more remote computing devices, wherein a subset of comprehensive vehicle quotes on the ranked list of comprehensive vehicle quotes characterized by the likelihood of acceptance above a threshold are initially transmitted to the one or more remote computing devices.

8. A method comprising:
receiving an inquiry from a consumer regarding at least one vehicle of interest;
collecting cost-related data from one or more sources associated with the least one vehicle of interest, wherein the cost-related data corresponds to a vehicle ownership cost over a lifecycle of vehicle ownership;
generating, using at least one machine learning model, a comprehensive vehicle quote comprising a total cost of vehicle ownership for the at least one vehicle of interest, wherein the comprehensive vehicle quote includes one or more of a vehicle purchase cost, a vehicle policy cost, or the vehicle ownership cost over the lifecycle of vehicle ownership;
determining, using the at least one machine learning model, a likelihood of acceptance that the consumer accepts the comprehensive vehicle quote; and
transmitting, based on a determination that the likelihood of acceptance is above a threshold, the comprehensive vehicle quote to a computing device associated with the consumer.

9. The method of claim 8, further comprising:
detecting a vehicle event during the lifecycle of vehicle ownership, wherein the vehicle event includes at least one of a vehicle maintenance event or a warranty expiration event;
generating, based on the detection of the vehicle event, an updated comprehensive vehicle quote including one or more updated parameters associated with the total cost of vehicle ownership; and
transmitting the updated comprehensive vehicle quote to the computing device.

10. The method of claim 8, further comprising:
monitoring data associated with the at least one vehicle of interest from one or more of a dealer management system, an external database, or an enterprise system;
detecting a change in cost associated with the at least one vehicle of interest, wherein the change in cost includes a vehicle cost, a vehicle policy cost, or a vehicle maintenance cost; and
transmitting an updated comprehensive vehicle quote to the computing device.

11. The method of claim 8, further comprising:
presenting, via a graphical user interface of the computing device, the comprehensive vehicle quote; and
generating, via the graphical user interface, one or more modifiable aspects of the comprehensive vehicle quote, wherein the comprehensive vehicle quote is modifiable via one or more inputs using the graphical user interface.

12. The method of claim 8, wherein the one or more sources include dealer management system data indicative of transactional data relating to the at least one vehicle of interest, and enterprise data indicative of policy data associated with the at least one vehicle of interest.

13. The method of claim 8, further comprising:
receiving, from one or more databases, historical data associated with the consumer, wherein the historical data includes one or more of a purchased vehicle, a vehicle policy, or a vehicle maintenance cost;
predicting, via the machine learning model and based on the historical data, one or more aspects of the comprehensive vehicle quote, wherein the one or more aspects include one or more of the vehicle purchase cost, the vehicle policy cost, or the vehicle ownership cost over the lifecycle of vehicle ownership; and
generating, via the machine learning model, the comprehensive vehicle quote including the one or more aspects.

14. The method of claim 13, further comprising memory storing computer-readable instructions that, when executed by the at least one processor, cause the at least one processor to:
selectively transmit, via a network, different portions of the ranked list of comprehensive vehicle quotes to one or more remote computing devices, wherein a subset of comprehensive vehicle quotes on the ranked list of comprehensive vehicle quotes characterized by the likelihood of acceptance above a threshold are initially transmitted to the one or more remote computing devices.

15. One or more non-transitory computer-readable media storing instructions that, when executed by a processor, cause the processor to:
receive an inquiry from a consumer regarding at least one vehicle of interest;
collect cost-related data from one or more sources associated with the least one vehicle of interest, wherein the cost-related data corresponds to a vehicle ownership cost over a lifecycle of vehicle ownership;
generate, using at least one machine learning model, a comprehensive vehicle quote comprising a total cost of vehicle ownership for the at least one vehicle of interest, wherein the comprehensive vehicle quote includes one or more of a vehicle purchase cost, a vehicle policy cost, or the vehicle ownership cost over the lifecycle of vehicle ownership;
determine, using the at least one machine learning model, a likelihood of acceptance that the consumer accepts the comprehensive vehicle quote; and
transmit, based on a determination that the likelihood of acceptance is above a threshold, the comprehensive vehicle quote to a computing device associated with the consumer.

16. The non-transitory computer-readable media storing instructions of claim 15, wherein when executed by the processor, cause the processor to:
detect a vehicle event during the lifecycle of vehicle ownership, wherein the vehicle event includes at least one of a vehicle maintenance event or a warranty expiration event;
generate, based on the detection of the vehicle event, an updated comprehensive vehicle quote including one or more updated parameters associated with the total cost of vehicle ownership; and
transmit the updated comprehensive vehicle quote to the computing device.

17. The non-transitory computer-readable media storing instructions of claim 15, wherein when executed by the processor, cause the processor to:
monitor data associated with the at least one vehicle of interest from one or more of a dealer management system, an external database, or an enterprise system;
detect a change in cost associated with the at least one vehicle of interest, wherein the change in cost includes a vehicle cost, a vehicle policy cost, or a vehicle maintenance cost; and
transmit an updated comprehensive vehicle quote to the computing device.

18. The non-transitory computer-readable media storing instructions of claim 15, wherein when executed by the processor, cause the processor to:
present, via a graphical user interface of the computing device, the comprehensive vehicle quote; and
generate, via the graphical user interface, one or more modifiable aspects of the comprehensive vehicle quote, wherein the comprehensive vehicle quote is modifiable via one or more inputs using the graphical user interface.

19. The non-transitory computer-readable media storing instructions of claim 15, wherein when executed by the processor, cause the processor to:
receive, from one or more databases, historical data associated with the consumer, wherein the historical data includes one or more of a purchased vehicle, a vehicle policy, or a vehicle maintenance cost;
predict, via the machine learning model and based on the historical data, one or more aspects of the comprehensive vehicle quote, wherein the one or more aspects include one or more of the vehicle purchase cost, the vehicle policy cost, or the vehicle ownership cost over the lifecycle of ownership; and
generate, via the machine learning model, the comprehensive vehicle quote including the one or more aspects.

20. The non-transitory computer-readable media storing instructions of claim 19, wherein when executed by the processor, cause the processor to:
selectively transmit, via a network, different portions of the ranked list of comprehensive vehicle quotes to one or more remote computing devices, wherein a subset of comprehensive vehicle quotes on the ranked list of comprehensive vehicle quotes characterized by the likelihood of acceptance above a threshold are initially transmitted to the one or more remote computing devices.
